(19) United States
(12) Patent Application Publication
(10) Pub. No.: US 2021/0069573 A1
(43) Pub. Date: Mar. 11, 2021

(54) SYSTEMS AND METHODS FOR ANALYZING AND DISPLAYING BASKETBALL OFFENSIVE SET DATA

(71) Applicant: KarmaJack LLC, Purcellville, VA (US)

(72) Inventor: Justin Joseph Beisel, Purcellville, VA (US)

(21) Appl. No.: 17/018,129

(22) Filed: Sep. 11, 2020

Related U.S. Application Data
(60) Provisional application No. 62/899,015, filed on Sep. 11, 2019.

(51) Int. Cl. A63B 71/06; A63B 24/00

(52) U.S. Cl. CPC A63B 71/0622; A63B 24/0021; A63B 2024/0056; A63B 2243/0037; A63B 2071/0694

(57) ABSTRACT

During an offensive possession of a basketball game, data regarding the possession is recorded and analyzed. Offensive set data is determined and displayed based on an offensive set type. Roster information specific to the offensive set data is analyzed and displayed with the offensive set data to help a coach or analyst determine the effectiveness of an offensive set or roster.

### CROSS-REFERENCE TO RELATED APPLICATION

This application is related to and claims the benefit of U.S. Provisional Patent Application No. 62/899,015 filed on Sep. 11, 2019. The aforementioned application is expressly incorporated herein by reference in its entirety.

### BACKGROUND

In the sport of basketball, two teams compete to place a basketball in a goal (e.g., make a basket). The team in possession of (e.g., control over) the basketball is considered the offensive team (e.g., the offense), and attempts to place the ball in the basketball of the opposing team. The opposing team is considered the defensive team (e.g., the defense), and attempts to prevent the offensive team from making a basket. Possession of the basketball may change multiple times during a game, and the offensive and defensive teams may similarly change.

During an offensive possession, the offense may execute a strategy (e.g., an offensive set) to maneuver around the defense to make a basket during an offensive play. Offensive set may be a general strategy in which members of the team move around the basketball court consistent with the general offensive set. A basketball team may further have a specific offensive set in which team members follow a series of prescribed motions to attempt to make a basket. A basketball team may train to use multiple offensive sets during a basketball season or even in the same basketball game.

During a basketball game, actions performed by each team and by individual members of the team may be tracked. For example, each basket a team makes may be recorded to maintain a current score of the game. Other offensive play information may be tracked, such as rebounds, assists, steals, fouls, 3-point attempts, 3-pointers made, 2-point attempts, 2-pointers made, free-throw attempts, free throws made, other information, and combinations thereof. Furthermore, this information may be tracked by the individual player. In this manner, an analyst (e.g., coach, spectator, reporter, individual, team, company, any other analyst, and combinations thereof) may track the performance of the team and/or individual members of the team.

The analyst may analyze the offensive play information. For example, the analyst may analyze the total number of shots taken compared to shots made to prepare a shot percentage. In some examples, the analyst may analyze the offensive play information for the team or for the individual.

### SUMMARY

In some embodiments, a method for analyzing a basketball game includes receiving offensive play data of a current offensive play during an offensive possession. The offensive play data includes an offensive set type and at least one of a number of passes during the current offensive play or a possession ending action. The possession ending shot includes a shot or a turnover. If the possession ending shot is a shot, then the offensive play data includes a shot player, a shot location, and a shot result. The method includes recording the offensive play data in an offensive play database. Offensive set data is then determined for the offensive play data and displayed on a display. In some embodiments, the current offensive set data includes a comparison between the current offensive set data and previous offensive set data in an offensive play database and current offensive set data is displayed simultaneously with the previous offensive set data.

In some embodiments, player information for a roster of players may be displayed. The player information includes a shot percentages for the offensive set type.

In some embodiments, the current offensive set data is specific to the roster of players, and the method includes changing the roster of players. Based on the change in the roster of players, the offensive set data specific to the changed roster of players is displayed.

In some embodiments, changing the roster of players includes substituting a player.

In some embodiments, a season shot percentage of the offensive set data is displayed. The season shot percentage is determined relative to a selected group of games.

In some embodiments, offensive set data is displayed for the last two minutes of a game.

In some embodiments, the offensive set type is a first offensive set type, and the previous offensive set data includes a second offensive set type that is different from the first offensive set type.

In some embodiments, a method for analyzing a basketball game includes receiving an input of an arbitrary area of interest on a basketball court. A plurality of shots taken in the area of interest is determined, the plurality of shots includes a shot result. A shot percentage of the plurality of shots is determined based on the shot result of each shot of the plurality of shots.

In some embodiments, the arbitrary area of interest is a circle having a center locatable on the basketball court.

In some embodiments, each shot of the plurality of shots includes a shot player, and the shot percentage includes a player shot percentage based on the shot player and the shot result.

In some embodiments, each shot includes a shot element. The shot element includes a catch-and-shoot type shot.

In some embodiments, the plurality of shots taken includes querying a database of shots taken. Each shot includes a shot location, and the plurality of shots in the area of interest is determined based on whether the location of each shot is in the area of interest.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 is a representation of a computing system;

FIG. 2 is a representation of a display of an analysis of offensive set data;

FIGS. 3-1 and 3-2 are representations of a display of another analysis of offensive set data;

FIG. 4 is a representation of a display of yet another analysis of offensive set data;

FIG. 5 is a representation of a display of still another analysis of offensive set data;

FIG. 6 is a representation of a display of a further analysis of offensive set data;

FIG. 7 is a representation of a display of yet further analysis of offensive set data;

FIG. 8 is a representation of a display of still further analysis of offensive set data;

FIG. 9-1 through 9-3 are representations of shot charts;

FIG. 10 is a representation of a display of more analysis of offensive set data;

FIG. 11 is a representation of a display of yet more analysis of offensive set data;

FIG. 12 is a representation of a display of still more analysis of offensive set data;

FIG. 13 is a representation of a method for analyzing a basketball game;

FIG. 14 is a representation of another method for analyzing a basketball game;

FIG. 15 is a representation of yet another method for analyzing a basketball game; and

FIG. 16 is a representation of certain components that can be included within a computing device

### DETAILED DESCRIPTION

This disclosure generally relates to devices, systems, and methods for analyzing basketball games. An analyst may receive offensive play data related to an offensive play, such as an offensive set type, a number of passes during the offensive play, a possession-ending action, shot player, shot location, shot result, roster information, and so forth. The analyst may use the offensive play data to analyze the offensive possession, such as analyzing the effectiveness of an offensive set type. The analyst may further use an application installed on a mobile device (or other computing device) to compare the results of the current offensive play with previous plays in the same game and/or previous offensive plays in previous games. The application may display this comparison in real-time. The analyst may then use the information to determine how the team is playing in the current game, how the team is performing compared to previous games, the effectiveness of the current set against the current opposing team and previous, similar opposing teams, and so forth. This data and analysis received in real-time may help the analyst to make changes to the team and/or to the team's offense to increase the effectiveness of the team.

According to embodiments of the present disclosure, an analyst may be anybody who receives, compares, analyzes, or otherwise uses information about a basketball game. Thus, in some embodiments, an analyst may be a coach, a player, a spectator, a newsperson, a commentator, a statistician, any other analyst, and combinations thereof.

According to embodiments of the present disclosure, an offensive play is the portion of a basketball game during which a team is in control of the basketball. The offensive play may begin at the time the team gains possession of the ball (such as through inbounding of the ball, a steal, a rebound, or other way to gain possession of the ball). The offensive play may end at the time the team loses possession of the ball (such as through a shot, the ball passing out of bounds, a foul call, a steal, or other way to lose possession of the ball). In some embodiments, the offensive play may be tracked by the shot clock. For example, when the shot clock is reset, a new offensive play may begin. Thus, in some embodiments, when the shot clock ends, the offensive play may end.

In some embodiments, an offensive play may end through a possession-ending action. The possession-ending action may be any action that causes the possession to end, such as a shot or a turnover. In some embodiments, a possession-ending action may be any action that causes the shot clock to reset. In some embodiments, a possession-ending action may be any action that causes possession of the basketball to change between teams.

In some embodiments, an offensive set type may be any type of coordinated offensive strategy performed by the team. In some embodiments, an offensive set type may be a general set of guidelines that players follow. In some embodiments, an offensive set type may be a specific series of movements that players follow. Examples of offensive set types include base, chest, raptor, horns, pistol, ram, rush, shade, swing, transition, chin, any other offensive set type, and combinations thereof. While reference may be made to specific offensive sets, it should be understood that any offensive set type may be used in accordance with embodiments of the present disclosure. Indeed, an offensive set may include custom offensive sets developed specifically by and/or for the team.

In accordance with embodiments of the present disclosure, offensive play data may include any information tracked with reference to an offensive position. For example, offensive play data may include information such as an offensive set type, a roster list (e.g., the biographical data of players, such as name, team, and jersey number), number of passes, shot taken, shot type, shot player, turnover, any other offensive play data, and combinations thereof.

While embodiments of the present disclosure have been discussed in reference to the game of basketball, it should be understood that the devices, systems, and methods discussed herein may be utilized in any sports context. For example, embodiments of the present disclosure may be with football teams, baseball teams, soccer teams, lacrosse teams, tennis players, and any other sport team.

Conventionally, offensive play data and/or offensive set data is analyzed after a game is over. For example, a coach and/or players may review offensive set data of their team after a game to determine areas of strength and areas for improvement. Furthermore, an analyst may analyze offensive set data of an opposing team to formulate a defensive plan to use against the opposing team. However, such analysis is, by nature, too late to help in the game during which the offensive play data is recorded. In accordance with embodiments of the present disclosure, preparation and/or analysis of offensive set data may be performed in real time. In other words, the application records offensive set data as it happens, and the application may analyze the offensive set data and display the resulting analysis in real time for the analyst. In this manner, the analyst may be responsive to game conditions as they occur. For example, the analysis may indicate that a player is playing better than his season average. A coach may review this analysis and determine that the player should play more minutes. Similarly, the analysis may indicate that a player is playing worse than his season average, and the coach may pull him from the game.

According to embodiments of the present disclosure, data retrieval and/or analysis may occur in real time. Real time may refer to the period of time between entry of data and/or a request for data analysis and the result of the analysis. In some embodiments, real time may be measured as a delay. The delay may be less than 1 millisecond, less than 1 second, less than 10 seconds, less than 1 minute, or any value therebetween. In some embodiments, real time may mean a delay that that is small enough to allow for a coach or other analyst to make a change in the current game.

Offensive play data may further be analyzed in real time to determine the effectiveness of certain game elements against the current opponent and/or similar opponents. For example, the analysis of offensive play data may indicate that the offensive set type horns is particularly effective against the current opponent. A coach may review this analysis and determine that the team should use the horns offensive set type more often during the game.

In some embodiments, an analyst may determine that certain offensive set types are more effective against different defensive schemes. For example, the analyst may determine that the offensive set type swing is most affective against a zone defense, and that the offensive set type base is most affective against a man-to-man defense. In some embodiments, the opposing team may change defensive schemes from zone to man-to-man defense. In accordance with embodiments of the present disclosure, when the opposing team changes defensive schemes, the analyst may, in real time, instruct the application to present a comparison of the most effective offensive set types for the changed defensive scheme. The analyst may then use this information to determine whether he should change the offense set type. In this manner, the analyst may be more responsive to changes in the game.

In some embodiments, an analyst may review offensive sets relative to a specific team or group of teams having similar defensive styles. For example, an analyst may select a group of games from a season, such as all games played within a time period (e.g., one week, two weeks, three weeks, one month, two months, the entire season). The offensive set data may be analyzed according to each game within the group of games. This may help the analyst to understand how the team has performed during the identified stretch of the season. In this manner, an analyst may identify trends or other elements of the team's performance over the season. In some embodiments, the analyst may select an arbitrary group of games. For example, the analyst may identify teams that have a similar defensive style, and select games played against those similar teams. The offensive set data may be reviewed relative to the selected group of games. In this manner, a coach or other analyst may review which offensive sets are effective against teams having the identified defensive style.

Certain portions of a game may have particular importance to an analyst. For example, during the last two minutes of a close game may be critical to winning the game (e.g., clutch situations). Different plays, roster lineups, and/or players may perform differently in clutch situations. The application may help to provide a real-time analysis of how different combinations of offensive sets, rosters, and individual players may perform in clutch situations.

According to embodiments of the present disclosure, the application may prepare a graphical shot chart overlayed on a virtual basketball court based on the type and result of shots in a basketball game. The analyst may select a shot region (e.g., a splash zone) of the shot chart to analyze. The shot region may be located at any location on the basketball court. The area contained within the shot region may then be separated from and analyzed independently from the rest of the basketball court. This may allow an analyst to determine how the team and/or a specific player are performing in the shot region.

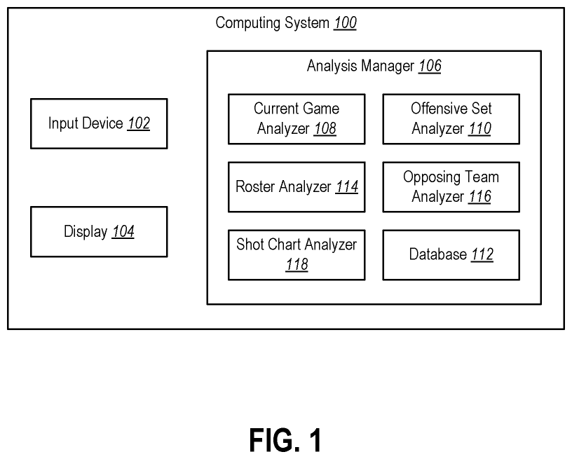

Referring now to the figures, FIG. 1 is a representation of a computing system 100, according to at least one embodiment of the present disclosure. The computing system 100 shown includes an input device 102 and a display 104. The input device 102 may be any input device configured to receive input. For example, the input device 102 may be a touch-screen display. In some examples, the input device may be a mouse, a track-pad, a keyboard, a microphone, any other input device, and combinations thereof. In some embodiments, basketball game information may be received from a remote location. For example, basketball game information may be received from the internet, from a different computer, from a cloud computing device, from any other remote location, and combinations thereof. In some embodiments, the computing system 100 may receive basketball game information wirelessly from another computing device.

The computing system 100 includes an analysis manager 106 used to analyze a basketball game. The analysis manager 106 may use input from the input device 102 to perform analyses of various aspects of the basketball game. The analysis manager 106 may generate reports based on the analysis of the basketball game and present them on the display 104. In some embodiments, the analysis manager 106 may analyze input from the input device 102 and automatically (e.g., without explicit user instructions) output an analysis to the display 104. In some embodiments, the analysis manager 106 may output the analysis to the display after receiving one or more instructions from a user.

A user may input basketball game information (e.g., offensive set data, discussed above) into the computing system 100 using the input device 102. The analysis manager 106 may receive the basketball game information from the input device 102. A current game analyzer 108 may analyze the basketball game information. For example, the current game analyzer 108 may analyze an offensive play and provide information about the offensive play. In some embodiments, the current game analyzer 108 may provide analysis of the current basketball game in real time. In other words, the current game analyzer 108 may analyze the basketball game information as soon as it is received from the input device 102. In this manner, the current game analyzer 108 may provide analysis for the analyzer to use during the current game. This may allow a coach to make changes to a team's strategy (such as roster changes or changes to the offensive strategy) responsive to events that occur during the game.

The analysis manager 106 may include an offensive set analyzer 110. The offensive set analyzer 110 may perform analyses on an offensive set. In some embodiments, the basketball information may be received as offensive set data. The offensive set data may include information about an offensive play, such as offensive set type, number of passes in the possession, possession-ending action (e.g., shot/turnover), shot type, shot player, shot result, and so forth.

The offensive set analyzer 110 may then analyze the offensive set data. In some embodiments, the offensive set analyzer 110 may work with the current game analyzer 108 to determine a success rate of the offensive set type during the game. In some embodiments, the offensive set analyzer 110 may determine a comparison of offensive set results, including a comparison between made shot, missed shot, foul, turnover, any other result, and combinations thereof.

In some embodiments, the offensive set analyzer 110 may compare the offensive set data to previous offensive sets stored in a database 112. The previous offensive sets stored in the database 112 may include offensive set data from the same team in other games. By comparing the offensive set data from the current game to previous offensive set data from previous games, a coach (or other analyzer) may be able to determine which offensive set types are most effective, which are working worse than average this game, which are working better than average this game, and so forth. In this manner, a coach may be able to make changes to offensive sets in real time based on the comparison between historical games and the current game.

In some embodiments, the analysis manager 106 includes a roster analyzer 114. The roster analyzer 114 may analyze the performance of the current roster (e.g., the players playing in the current game). In some embodiments, the roster analyzer 114 may analyze the offensive set data received from the input device 102. For example, the roster analyzer 114 may analyze the player who made a shot (e.g., the shot player) and determine a shot percentage for the game and/or for the season (based on previous game information from the database 112). In some examples, the roster analyzer 114 may analyze other information about an individual, such as turnovers, assists, and so forth.

In some embodiments, the roster analyzer 114 may analyze information about a combination of players. For example, the roster analyzer 114 may analyze how effective (e.g., a success rate) a particular offensive set type is with a particular roster combination (e.g., a particular combination of players). In some embodiments, the roster combination may include all 5 players on the court. In some embodiments, the roster combination may include 4 players, 3 players, or 2 players.

In some embodiments, the roster analyzer 114 may perform analysis of offensive set data in real time. In this manner, a coach or other analyzer may use the comparisons and other analyses from the roster analyzer 114 to make changes to the roster and/or the offensive sets during the course of a game. This may improve the coach's flexibility and improve the effectiveness of the team.

The analysis manager 106 may further include an opposing team analyzer 116. The opposing team analyzer 116 may receive and analyze the offensive set data to determine the effectiveness of a particular offensive set type against an opposing team and/or similar opposing teams. For example, an opposing team may have a defensive style. The offensive set data may include the defensive style of the opposing team, and the opposing team analyzer 116 may determine the effectiveness of an offensive set type, a roster, or other portion of the offensive play data, against the defensive style of the opposing team.

In some embodiments, the opposing team analyzer 116 may analyze multiple offensive set types from the database 112 and determine the effectiveness (e.g., success rate) of each offensive set type compared to a defensive scheme. For example, defensive scheme may be broadly categorized into two categories, zone and man-to-man defense. The opposing team analyzer 116 may analyze offensive set data relative to the defensive scheme. For example, the opposing team analyzer 116 may analyze a success rate, such as a scoring rate, of an offensive set type based on the defensive scheme. This may allow a coach to select the offensive set type that is most likely to succeed against the defensive scheme. In some embodiments, the opposing team analyzer 116 may analyze offensive set data in real time. In this manner, if an opposing team changes the defensive scheme during the game, a coach may utilize the opposing team analyzer 116 to determine to which offensive set type she should change to counter the new defensive scheme. In some embodiments, a coach may use the opposing team analyzer 116 to change the offensive set type without a prior change in defensive scheme.

The analysis manager may further include a shot chart analyzer 118. The shot chart analyzer 118 may generate and analyze shot charts of the current and previous basketball games. In some embodiments, the shot chart analyzer 118 may generate an icon for each shot made during a game. The icon may be placed at the location the shot was made. The shape and/or color of the icon may indicate elements of the shot, including a made shot, a missed shot, a catch-and-shoot shot, a dribble-and-shoot shot, a dunk, a 3-pointer, a fouled shot, an assisted shot, the shot player, any other shot information, and combinations thereof.

In some embodiments, the shot chart analyzer 118 may allow a user to modify and/or change the shot chart information on the shot chart. For example, the shot chart analyzer 118 may allow the user to select which shots are presented on the shot chart. A coach may use this feature to view the shots for a specific player or a specific combination of players (e.g., 2, 3, 4, or 5 players). In some embodiments, the shot chart analyzer 118 may allow a user to select an arbitrary area of interest on the court. The arbitrary area of interest may have an origin at any location on the court, and may encompass any amount of area. This may allow a coach to analyze the shot data from the arbitrary area of interest, which may help the coach to identify areas of the court where the players are strong or weak shooters. In some embodiments, the shot chart analyzer 118 may operate in real time to provide timely updates to a shot chart, thereby allowing a coach to use the data in the shot chart to provide timely adjustments to the team's offensive strategy.

In some embodiments, the elements of the analysis manager 106 may work together to provide data to the user. For example, the current game analyzer 108 may work with the offensive set analyzer 110, the roster analyzer 114, the opposing team analyzer 116, the shot chart analyzer 118, and combinations thereof, to provide real time data analysis of the current game. In some embodiments, the offensive set analyzer may work with the roster analyzer 114, the opposing team analyzer 116, and/or the shot chart analyzer 118 to provide analysis of the results of particular offensive sets in different conditions. The roster analyzer 114 may work with the opposing team analyzer 116, the shot chart analyzer 118, and/or the offensive set analyzer 110 to determine the effectiveness of particular roster combinations in differing conditions. Similarly, any of the elements of the analysis manager 106 may utilize the database 112 to compare conditions of the current game to previous, historical games stored in the database 112. In this manner, the analysis manager 106 may perform varied and detailed analyses of the current game based on offensive set data received from the input device 102.

In some embodiments, the results of analysis from various elements of the analysis manager 106 may be displayed on the display 104. The results of analysis of the current game may be displayed simultaneously (e.g., at the same time, visible on the same screen) with results from previous games. The results of various offensive set analyses may be displayed simultaneously for easy comparison. In this manner, a coach or other analyst may review the analysis from the analysis manager and make changes to the team's offensive strategy based on the analysis. This may help a coach to better manage a team, thereby increasing the team's offensive capabilities, improving the team's score, and increasing the wins a team has in a season.

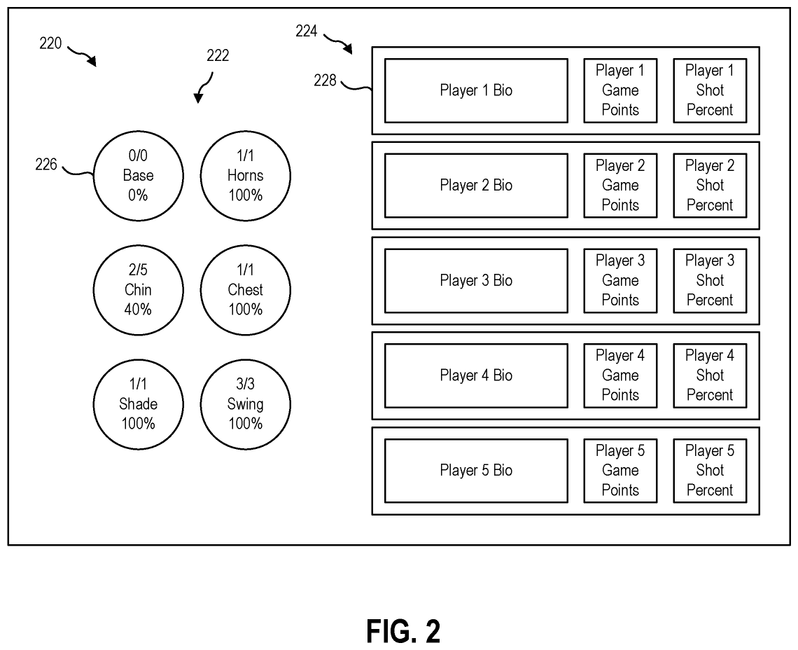

FIG. 2 is a representation of a display 220 of the results of an analysis of offensive set data, according to at least one embodiment of the present disclosure. The display 220 of FIG. 2 may be displayed on the display 104 of FIG. 1, and the information presented on the display 220 may be provided by the analysis manager 106 of FIG. 1.

The display 220 may be a representation of an offensive set analysis. The display 220 may include a plurality of offensive set list 222 and a roster 224. the offensive set list 222 may include a plurality of offensive sets 226. Each offensive set 226 may include a name of the offensive set (e.g., “Base”), a number of scores/attempt of the offensive set 226 (e.g., 0/0), and a success rate of the offensive set 226 (e.g., 0%). While the embodiment shown includes six offensive sets 226, it should be understood that the offensive set list 222 may include any number of offensive sets 226, including 1, 2, 3, 4, 5, 6, 7, 8, 9, 10, 11, 12, 13, 14, 15, or more offensive sets 226, depending on the preferences of the user and/or the coach.

In some embodiments, the offensive set list 222 may include current offensive set data and/or results about the current game. In some embodiments, the offensive set list 222 may include current offensive set data and/or results about previous games. In some embodiments, the offensive set list 222 may include both current offensive set data and/or results about the current game and previous games.

The roster 224 may include player information 228 about a roster of players. The player information may include player biographical information (such as name, team, jersey number, height, weight, and so forth), game points, season points, game shot percentage, season shot percentage, other biographical information, and combinations thereof. In some embodiments, the roster 224 may include player information 228 for the players currently playing on the court. In some embodiments, the roster 224 may include player information 228 for players not currently playing on the court. In some embodiments, the roster 224 may include each player playing on the court, and when a player is substituted in, the roster 224 may be updated with the substitute player's information 228.

In some embodiments, the offensive set list 222 and the roster 224 may be related. For example, the offensive sets 226 in the offensive set list 222 may include success rates based on the specific lineup in the roster 224. In some embodiments, the offensive set list 222 may not be related to the roster 224. For example, the offensive sets 226 may be related to the team as a whole, and not to the players listed in the roster 224.

In some embodiments, the display 220 may include other game information, such as the quarter, the time remaining in the quarter, the shot clock, the score, the total number of possessions, the number of turnovers, any other game information, and combinations thereof. While the embodiment shown in FIG. 2 does not include other game information, it should be understood that such information may be included in any location on the display 220.

Conventionally, a coach may utilize general game statistics to evaluate the performance of a team. However, without information regarding specific offensive sets, the coach may not know the reason for the team's performance. In accordance with embodiments of the present disclosure, a coach may utilize the offensive set list 220, which may include information about the effectiveness of offensive sets in the current game, to more precisely analyze a team's effectiveness using different offensive set types. This may help a coach to plan a team's offensive strategy, and particularly which offensive set types the team may use. This may increase the team's chance of scoring and therefore winning a game.

In some embodiments, to update information about a specific offensive play, a user may press on the offensive set 226 corresponding to the offensive set type used in the offensive play. This may allow the user to enter offensive play data regarding the offensive play, such as number of passes, possession termination action, shot player, shot result, and so forth. In this manner, data entry may be simple and quick. This may improve the accuracy of the data entered, and allow a user to focus on the analysis of the data, rather than on inputting the data itself.

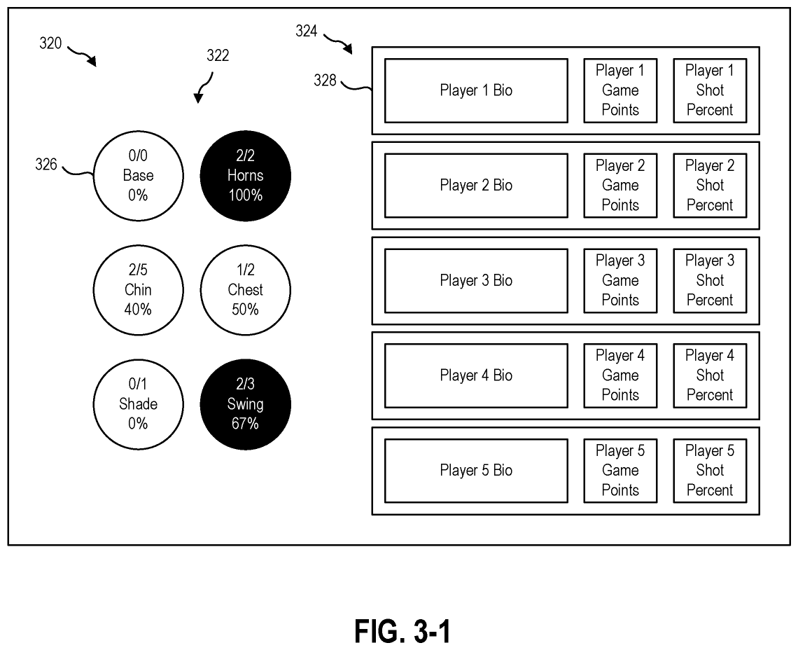

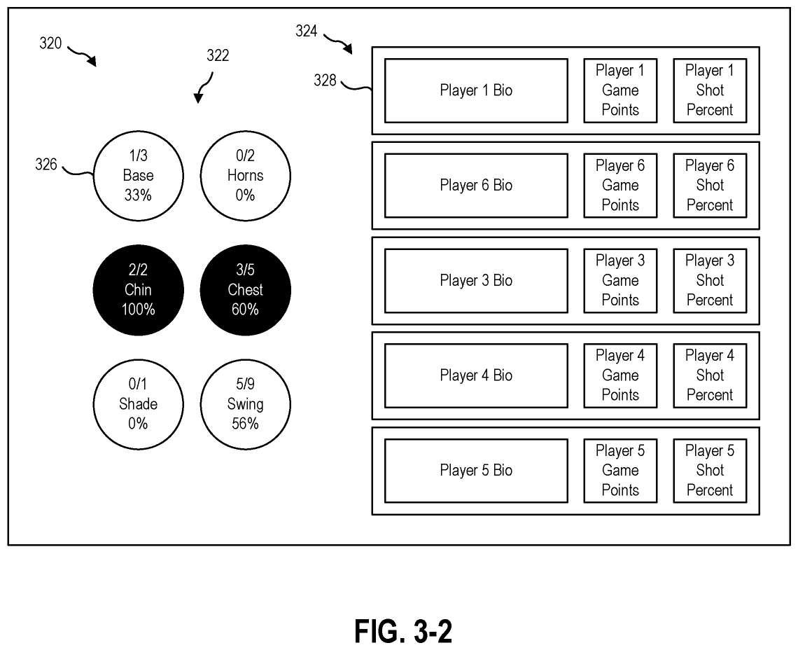

FIG. 3-1 is a representation of a display 320 of the results of an analysis of offensive set data, according to at least one embodiment of the present disclosure. The display 320 of FIG. 3 may be displayed on the display 104 of FIG. 1, and the information presented on the display 320 may be provided by the analysis manager 106 of FIG. 1.

In the embodiment shown, the user has requested that the analysis manager analyze which offensive sets 326 in the offensive set list 322 are the most effective. This request may be made using a selectable option on the display 320 (not shown), or using another input mechanism, such as an input from a file menu, a voice-activated request, or other request. The analysis manager may then review the available offensive sets 326 and identify which offensive sets have the highest success rates. In some embodiments, the analysis manager may present the most effective offensive sets on the display. For example, the analysis manager may re-organize the available offensive sets 326 according to the most effective (e.g., most successful) offensive sets.

In some examples, such as in the embodiment shown, the offensive sets 326 titled “horns” and “swing” have been highlighted as having the highest rate of success. The offensive sets 326 titled “base,” “chin,” “chest,” and “shade” have not been highlighted, indicating that those offensive sets are not the most effective offensive sets 326 available. In this manner, a coach or other analyst may determine which offensive sets 326 are the most effective, thereby enabling the coach to select the offensive set that will best help the team score more points and win more games.

In the embodiment shown, the top two most effective offensive sets 326 are highlighted based on the highest success rate. However, it should be understood that any selection criteria may be used to determine which offensive sets 326 to highlight. For example, the offensive sets 326 with the highest number of successful attempts may be highlighted, the offensive sets 326 with the highest total number of attempts, the offensive sets 326 with a specified minimum number of total attempts, any other selection criteria, and combinations thereof.

In some embodiments, any highlighting mechanism may be used to highlight the most effective offensive sets. For example, the most effective offensive sets may be highlighted with a different color, a darker or lighter backlight, a different shade of the same color, bold lines and/or text, a different shaped icon (e.g., square or triangle, rather than circle), different outline effects (e.g., dashed lines, sunburst outline), and so forth.

In the embodiment shown, the offensive sets 326 are not displayed in any particular order. However, it should be understood that the offensive sets 326 may be displayed in any order available, including number of successful attempts, total number of attempts, highest attempt success rate, alphabetical based on the name, any other order, and combinations thereof.

As discussed above, in some embodiments, the roster 324 may include player information 328 for players current playing in the basketball game. In some embodiments, the roster 324 may include player information 328 for any combination of players. In some embodiments, the offensive set list 322 may be specific to the combination of players shown in the roster 324. Therefore, the highlighted offensive sets 326 may be the most effective offensive sets for the combination of players included in the roster 326, which may be different than the most effective sets for the team as a whole.

In some embodiments, the offensive set list 322 may change when a player is substituted. For example, FIG. 3-2, the roster 324 shows that the player 6 has been substituted for player 2. When player 6 became part of the roster, the highlighted offensive sets 326 in the offensive set list 322 changed. This indicates that different offensive sets 326 may be more effective with the particular roster shown. In this manner, by changing the roster 324, a coach or other analyst may determine which offensive sets 326 are most effective for a given roster combination.

In some embodiments, the roster 324 may be changed in real time. In other words, the roster 324 may be changed during a game. Thus, if a coach is considering substituting a player and/or has substituted a player, then the coach may change the roster 324 to include the change. The coach may then review the offensive set list 322 for highlighted effective offensive sets 326. This may help a coach determine how best to make changes to the team during a game, including which offensive sets 326 to run with a particular roster when a substitution is made.

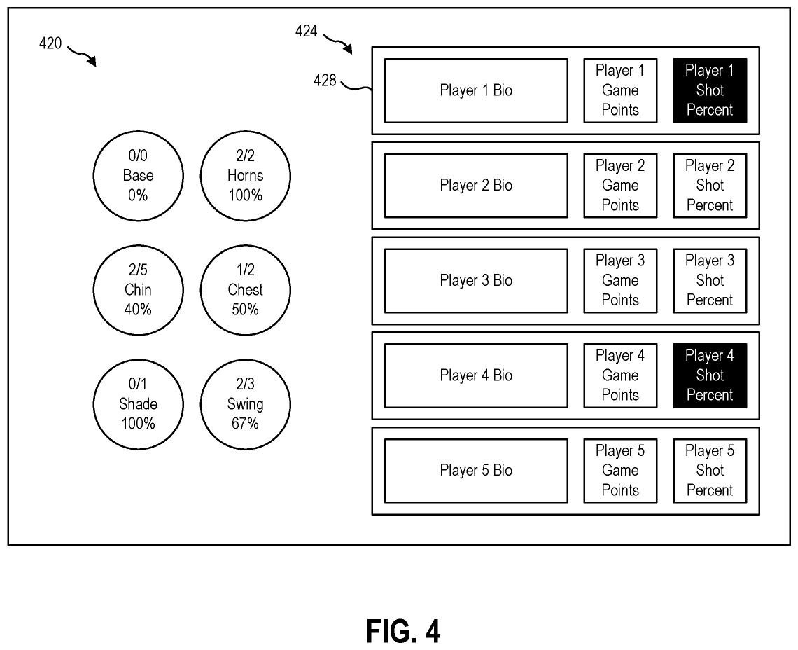

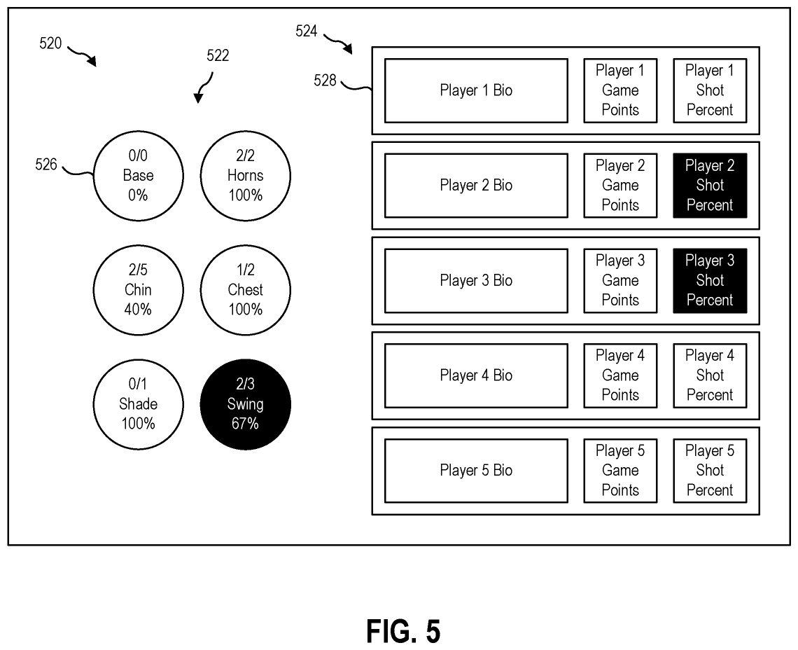

FIG. 4 is a representation of a display 420 of the results of an analysis of offensive set data, according to at least one embodiment of the present disclosure. The display 420 of FIG. 5 may be displayed on the display 104 of FIG. 1, and the information presented on the display 420 may be provided by the analysis manager 106 of FIG. 1.

In some embodiments, the analysis manager may provide an analysis of how players are performing in the game. The analysis manager may then highlight fields of player information 428 in the roster 424. For example, in the embodiment shown, the analysis manager may highlight the player information 428 of player 1 for having the highest shot percentage. In some embodiments, the analysis manager may highlight the player information of the player having the highest total game points. In some embodiments, the analysis manager may highlight player information 428 if a player makes a certain number of baskets in a row. For example, the analysis manager may highlight the player information of player 1 if player 1 has made 3 shots in a row (or any number of shots in a row). In some embodiments, the analysis manager may highlight the player information of a player if he has a running average above a certain shot percentage (e.g., three out of the last five shots, two out of the last three shots). This may provide a visual cue to the coach that player 1 is playing well. In this manner, a coach may encourage the player 1 to shoot more.

In some embodiments, the analysis manager may highlight player information 428 if a player is performing poorly. For example, in the embodiment shown, the analysis manager may highlight the player information 428 of player 4 for having the lowest shot percentage. In this manner, a coach may determine who is playing well, and who is playing poorly. This may help a coach to determine which players should receive the ball more, and which players should perform a supporting role. In some embodiments, the analysis manager may highlight player information 428 if a player misses a certain number of baskets in a row. For example, the analysis manager may highlight the player information of player 4 if player 4 has missed 3 shots in a row (or any number of shots in a row). In some embodiments, the analysis manager may highlight the player information of a player if he has a running average below a certain shot percentage (e.g., two out of the last five shots, one out of the last three shots). This may provide a visual cue to the coach that player 4 is getting tired or otherwise not performing well. In this manner, a coach may substitute another player in for player 4 to give player 4 a rest.

In some embodiments, the analysis manager may perform a comparison of how players are performing relative to a season average and/or a previous game. For example, in the embodiment shown, the analysis manager may highlight the player information 428 for player 1 for having a higher shot percentage than his season average. Similarly, in the embodiment shown, the analysis manager may highlight the player information 428 for player 4 for having a lower shot percentage than his season average. This may similarly help the coach to know which players to encourage to receive the ball more, and which players to encourage to play a supporting role.

FIG. 5 is a representation of a display 520 of the results of an analysis of offensive set data, according to at least one embodiment of the present disclosure. The display 520 of FIG. 5 may be displayed on the display 104 of FIG. 1, and the information presented on the display 520 may be provided by the analysis manager 106 of FIG. 1.

The display 520 includes an offensive set list 522 having one or more offensive sets 526. The user may select an offensive set 526, which may then be highlighted. In some embodiments, the analysis manager may change the player information 528 in the roster 524 to reflect player information specific to the selected offensive set 526. Thus, the player information 528 may include game points specific to the offensive set 526 and a game shot percentage specific to the offensive set 526.

In some embodiments, the player information 528 of the most effective player for the offensive set 526 may be highlighted. For example, in the embodiment shown, player 2 has the most effective shot percentage for the “swing” offensive set 526. This may help a coach know which player should be shooting the ball when running the identified offensive set 526.

In some embodiments, the player information of the least effective player for the offensive set 526 may be highlighted. For example, in the embodiment shown, player 3 has the least effective shot percentage for the “swing” offensive set 526. This may help the coach know which player should not be shooting the ball when running the identified offensive set 526. In some embodiments, the highlight for the most effective player may be different from the highlight for the least effective player.

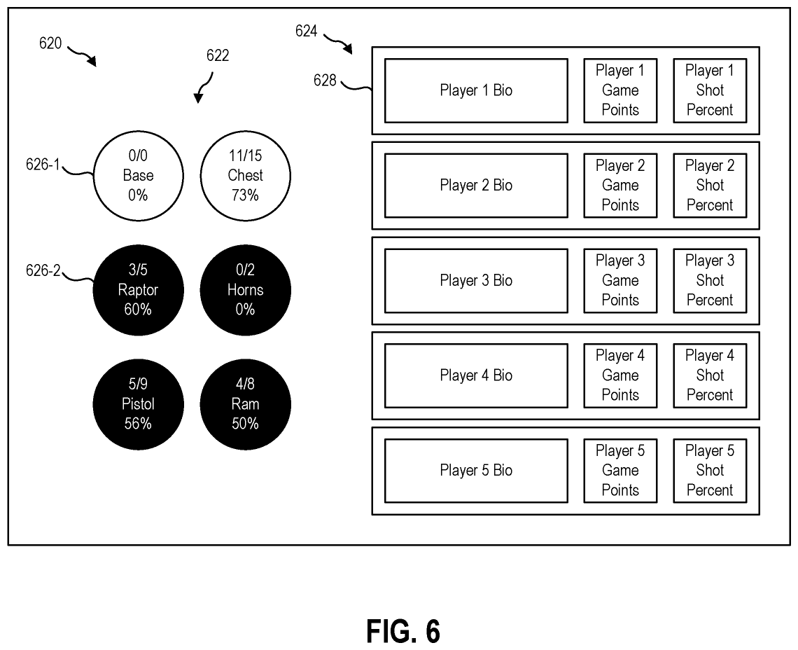

FIG. 6 is a representation of a display 620 of the results of an analysis of offensive set data, according to at least one embodiment of the present disclosure. The display 620 of FIG. 6 may be displayed on the display 104 of FIG. 1, and the information presented on the display 620 may be provided by the analysis manager 106 of FIG. 1.

The display 620 may include an offensive set list 622 of a plurality of offensive sets (collectively 626). The offensive set list 622 may be used to determine the most effective offensive sets based on a defensive scheme. For example, first offensive sets 626-1 may be particularly effective against a man-to-man defense, and second offensive sets 626-2 may be particularly effective against a zone defense. This may help a coach to select an offensive set 626 that may be effective against a man-to-man or a zone defense strategy.

In some embodiments, the offensive set list 622 may be specific to the specific players listed in the roster 624. Thus, and similar to embodiments described above, by changing the roster 624, the user may change the information in the offensive sets 626 and/or the offensive sets 626 included in the offensive set list 622. This may help a coach to decide which offensive set 626 to use with a specific roster against a specific defensive strategy.

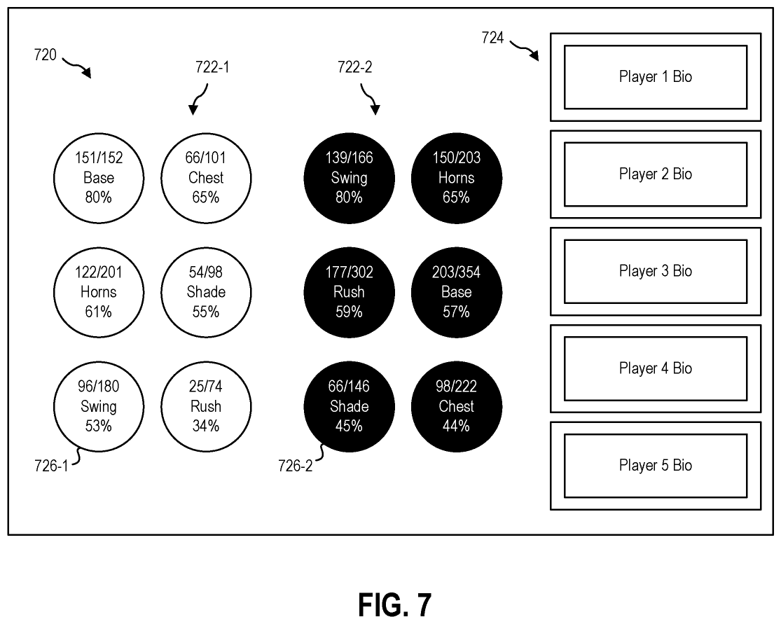

FIG. 7 is a representation of a display 720 of the results of an analysis of offensive set data, according to at least one embodiment of the present disclosure. The display 720 of FIG. 7 may be displayed on the display 104 of FIG. 1, and the information presented on the display 720 may be provided by the analysis manager 106 of FIG. 1.

The display 720 may include a first offensive set list 722-1 and a second offensive set list 722-2. The analysis manager 106 may analyze current and/or historical offensive set data to develop the first offensive set list 722-1 and the second offensive set list 722-2. The first offensive set list 722-1 may include first offensive sets 726-1 and the second offensive set list 722-2 may include second offensive sets 726-2.

In some embodiments, the first offensive set list 722-1 and the second offensive set list 722-2 may be used to compare the effectiveness of offensive sets (collectively 726) in two different situations. For example, in the embodiment show, the first offensive set list 722-1 may be directed to the effectiveness of the first offensive sets 726-1 against a man-to-man defensive scheme or strategy and the second offensive set list 722-2 may be directed to the effectiveness of the second offensive sets 726-2 against a zone defensive scheme or strategy. In this manner, a coach or other analyst may determine which offensive sets 726 are the most effective against a given defensive strategy. Furthermore, a coach or other analyst may review how a team plays the offensive sets 726, and work to improve offensive sets that are less effective against either a zone or a man-to-man defense.

In some embodiments, the offensive set lists (collectively 722) may be used to compare other information. For example, the first offensive set list 722-1 may represent offensive sets used in the current game and the second offensive set list 722-2 may represent offensive sets used in a previous game and/or throughout the entire season, and the first offensive set list 722-1 may be displayed simultaneously as with the second offensive set list 722-2. In some examples, the offensive set lists 722 may represent any set of information collected about a basketball game, including the effectiveness of offensive sets 726 against specific teams, the effectiveness of offensive sets 726 during specific portions of a game, such as specific quarters or clutch situations (e.g., in the last two minutes of a game), the effectiveness of offensive sets 726 at home and/or away games, any other set of information, and combinations thereof. This may help a coach to tailor the offensive set to a particular circumstance, thereby increasing the chance of scoring additional points and/or winning a game.

In some embodiments, the offensive sets 726 may be specific to the listed roster in the roster 724. In some embodiments, the offensive sets 726 may be generic to the team. In some embodiments, changing the roster 724 may change the offensive sets 726 listed and/or the values represented within the offensive sets.

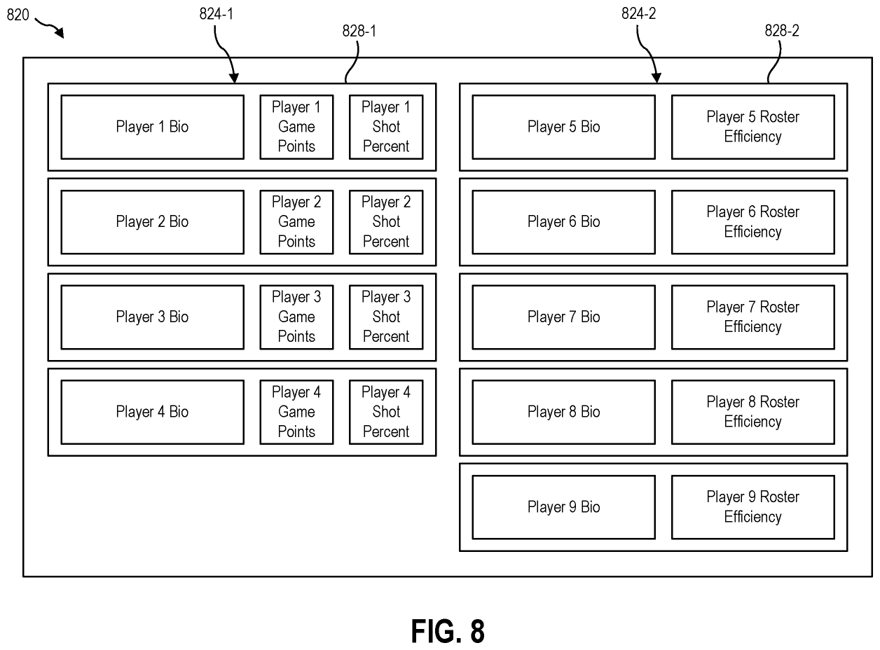

FIG. 8 is a representation of a display 820 of the results of an analysis of offensive set data, according to at least one embodiment of the present disclosure. The display 820 of FIG. 8 may be displayed on the display 104 of FIG. 1, and the information presented on the display 820 may be provided by the analysis manager 106 of FIG. 1.

In the embodiment shown, the display 820 includes a first roster 824-1 and a second roster 824-2. The first roster 824-1 may include first player information 828-1 of players on an actual or a hypothetical team roster. The player information 828-1 may include information about the effectiveness of each player in the specific roster of the first roster information. In the embodiment shown, the first roster 824-1 only includes four players, however it should be understood that the roster information may include any number of players, including 1, 2, 3, 4, or 5 players.

The second roster 824-2 may include second player information 828-2 for players not included in the first roster information 824-1. The second player information 828-2 may include offensive information regarding how each player in the second roster may perform with the combination of players in the first roster 824-1. In this manner, a coach may select player best suited to play with the first roster 824-1.

In some embodiments, the player information (collectively 828) may be determined based on an offensive set (such as an offensive set 226 of FIG. 2). By changing the offensive set, the coach and/or the analyst may prepare the most effective roster of players for each offensive set. This may help a team to score and therefore win games.

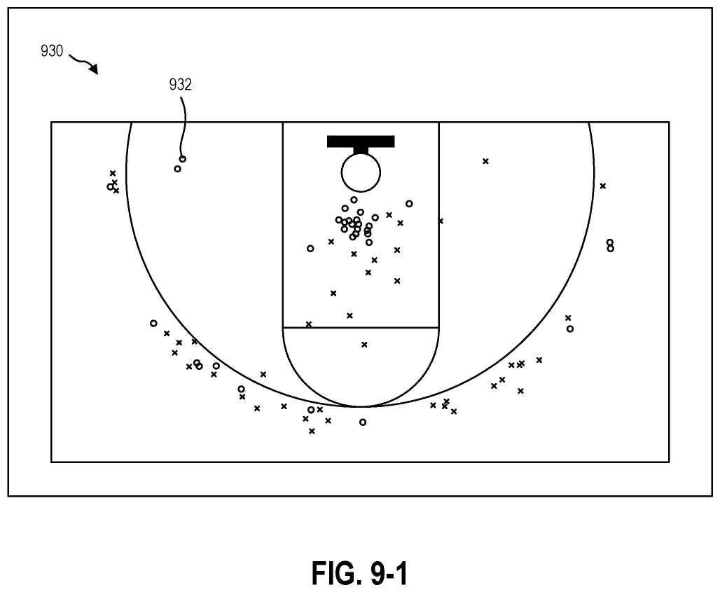

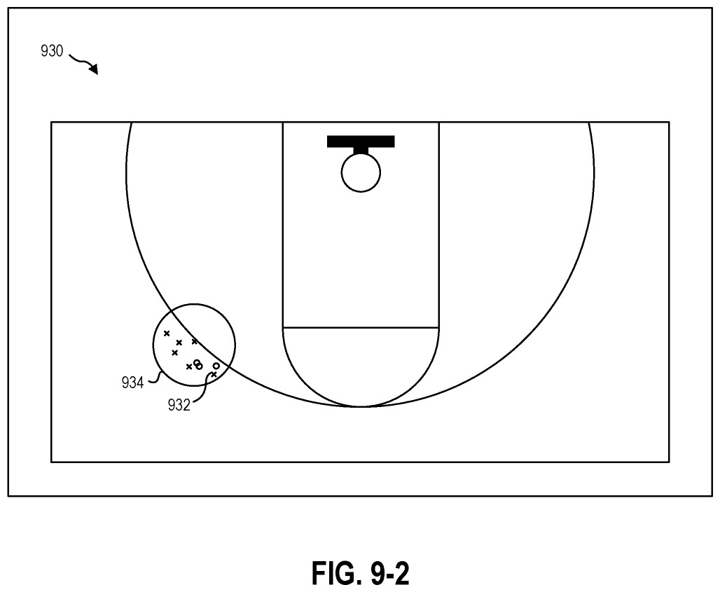

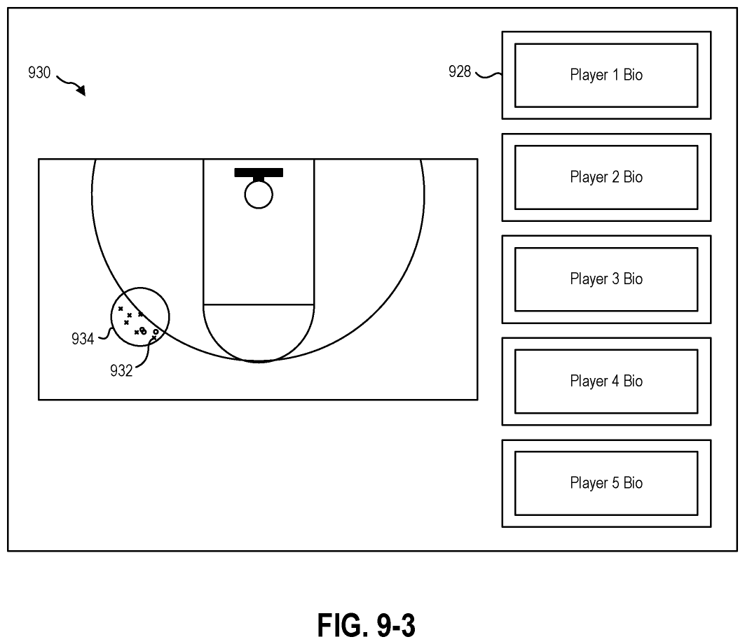

FIG. 9-1 is a representation of a shot chart 930, according to at least one embodiment of the present disclosure. The shot chart 930 may be generated using the analysis manager 106 of FIG. 1 and presented on the display 104.

The shot chart 930 may be a representation of each shot 932 taken during a time period, such as a quarter, a portion of a quarter, a clutch situation, a game, a portion of a season, or an entire season. The shot chart 930 may furthermore be a representation of a single player, a combination of players, or an entire team.

The shots 932 may have different symbols and/or colors to represent different shot elements. For example, a made shot 932 may have a circle symbol, and a missed shot may have an x symbol. In some examples, any shot element may be represented on the shot chart 930, such as a catch-and-shoot shot, a shot made during an offensive set, a shot that drew a foul, any other shot element, and combinations thereof.

In some embodiments, an analyst may desire to review information from a specific area of the shot chart 930. For example, FIG. 9-2 is a representation of the shot chart 930 of FIG. 9-1 with a selected area of interest 934. A user may select the area of interest 934 and the analysis manager may identify and display the shots 932 within the area of interest 934. This may allow the user to isolate and review the effectiveness of shots within the area of interest 934. This may help the user to determine the effectiveness of shooting in the identified area of interest 934. In this manner, a coach or other user may identify strengths and areas of improvement by the team in a particular location. In combination with shots displayed having specific shot elements, this may further allow an analyst to identify which shot elements are effective inside the area of interest 934.

In some embodiments, the area of interest 934 may include a shot result, which is whether the shot is made or missed. In some embodiments, the area of interest may include a shot percentage, which is the percentage of made shots to missed shots. This may help the coach or other analyst to determine the likelihood that a shot will be made within the area of interest 934. In some embodiments, a shot percentage may be formed using any shot element. For example, a shot percentage may be formed using a shot type, such as a catch-and-shoot type shot to form a catch-and-shoot shot percentage.

In some embodiments, the area of interest 934 may be an arbitrary area of interest. In other words, the area of interest 934 may be located at any location on the court represented on the shot chart 930. For example, the area of interest 934 is shown as a circle, with the center being located just outside of the three-point line. However, it should be understood that the area of interest may be arbitrarily located anywhere on the shot chart. In some embodiments, arbitrarily locating the area of interest may include not having pre-defined or pre-identified areas of interest 934.

In some embodiments, to determine which shots 932 to include in the area of interest 934, the analysis manager may query a database (e.g., database 112 of FIG. 1) of shots taken. Each shot in the database may include the shot elements, including location of the shot. The analysis manager may determine if a shot in the database was taken within the area of interest 934. If the shot was taken within the area of interest, then the shot may be included in the shot chart 930.

In some embodiments, the user may select the boundaries of the area of interest 934. For example, the user may select the center and radius/diameter of the area of interest 934. In the embodiment shown, the user may identify the shape of the area of interest. for example, the user may identify the area of interest as a circle, a triangle, a square, a pentagon, a hexagon, a polygon of any number of sides, a non-polygonal shape, any other shape, and combinations thereof.

In some embodiments, the user may select multiple areas of interest 934. For example, a user may select two areas of interest 934 in different locations of the shot chart to review. In this manner, the user may identify areas of effectiveness and/or areas for improvement. In some embodiments, each area of interest may identify shots 932 having the same shot elements. In some embodiments, each area of interest may identify shots 932 having different shot elements.

In the embodiment shown in FIG. 9-3, the analysis manager has identified and listed shot players who have attempted a shot within the region of interest 934. The player information 928 of each shot player may include the player's effectiveness within the region of interest 934. In this manner, if an offensive set is designed to develop a shot within the region of interest 934, a coach may identify the players most likely to make the shot within the region of interest 934. This may improve the chances of scoring and therefore improve the chances to win a game.

In some embodiments, the region of interest 934 may include shots 932 having shot elements. For example, the region of interest 934 may include shots 932 from the season during clutch situations. The coach may use the region of interest 934 to draw up a play with a shot in the region of interest 934, and may identify which players have the best shooting rate within the region of interest. This may help the coach to identify which player should receive the ball during play in the clutch situation. In some embodiments, the analysis manager may help to identify players who struggle in clutch situations. This may help a coach to remove such players from a game, or to identify these players for additional training on performing during clutch situations.

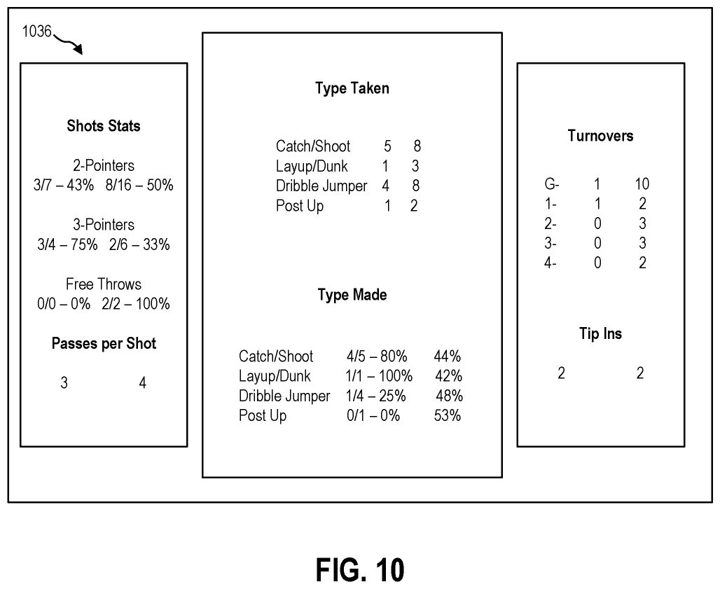

FIG. 10 is a representation of an offensive summary 1036, according to at least one embodiment of the present disclosure. The offensive summary 1036 may include an analysis performed by the analysis manager 106 of FIG. 1 and presented on the display 104.

The offensive summary 1036 may include offensive set data about the current offensive set and/or the current offensive game compared to other information. For example, the offensive summary 1036 shown includes current offensive set data from the current game shown in normal typeface, and offensive set data for previous games against any opponent in bold. For example, the offensive summary 1036 may include offensive set data for the same opponent, or offensive set data for any other opponent or groups of opponents. For example, a coach or other analyst may identify teams having similar defensive styles. The coach may select a group of games during the season, such as all the games within a period of time (e.g., one week, two weeks, three weeks, one month, two months, the entire season), or an arbitrary group of games selected by the user. In this manner, the coach or analyst may prepare game plans responsive to a specific opponent.

Simultaneously displaying the current offensive set data with the previous offensive set data may allow a coach or other user to compare how the team is performing against the same opponent during the game. In this manner, the coach or other user may be able to provide insights regarding the effectiveness of specific plays or other offensive strategies being used in the current game. In some embodiments, the offensive summary 1036 may include an analysis of the effectiveness of one or more offensive sets against the opposing team in the current game compared to the previous game.

In some embodiments, the team may not have played an identified opponent. However, a user may have identified a team that is similar. For example, another opposing team may have a similar defensive style. The user may include the offensive set data from the similar opposing team in the offensive summary 1036. This may allow a coach or other user to estimate how the team may perform when faced with the identified opponent.

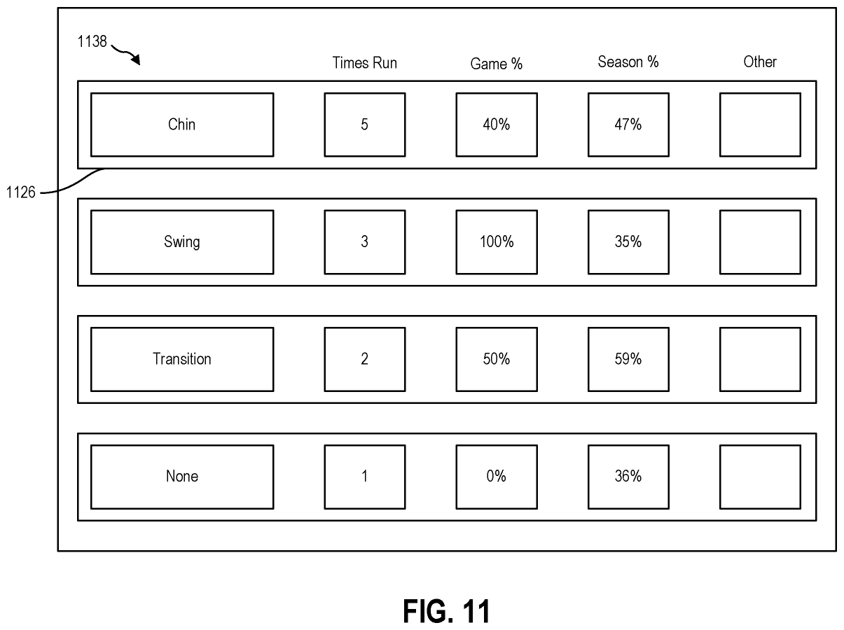

FIG. 11 is a representation of an offensive set summary 1138, according to at least one embodiment of the present disclosure. The offensive set summary 1138 may include an analysis performed by the analysis manager 106 of FIG. 1 and presented on the display 104.

The offensive set summary 1138 may include a comparison of different offensive sets 1126. The offensive set summary 1138 may include one or more elements of offensive set data for each offensive set 1126, such as the times run during a game, the game percentage, a previous game percentage, the season percentage, any other offensive set data, and combinations thereof.

In some embodiments, a coach or other user may utilize the offensive set summary to review the effectiveness of an offensive set 1126 in the game and compare it to other games and/or the season. This may allow a coach or other user to determine which offensive sets 1126 are being more effective in the current game and which sets are being less effective. In this manner, a coach may change the offensive sets during the game to focus on the sets that are the most effective for the game.

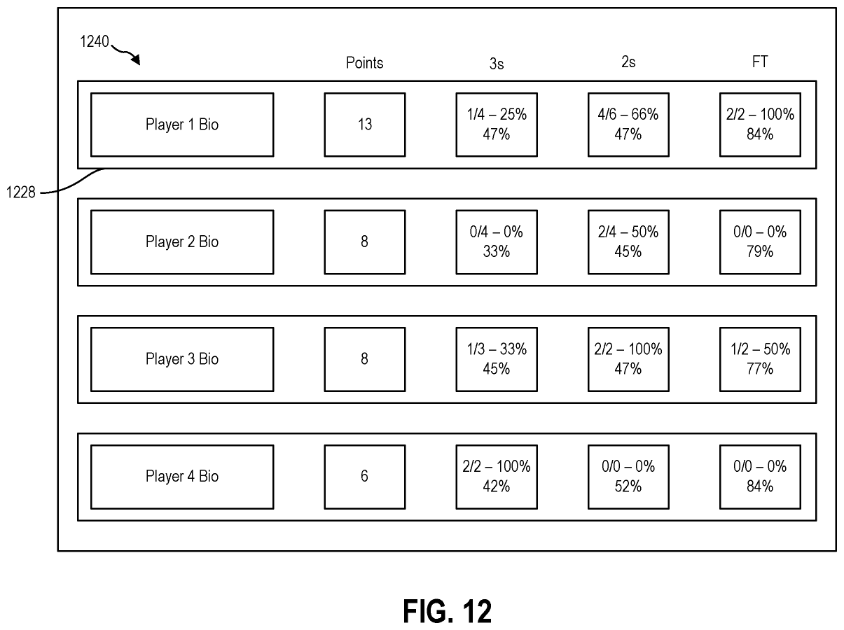

FIG. 12 is a representation of a roster summary 1240, according to at least one embodiment of the present disclosure. The roster summary 1240 may include an analysis performed by the analysis manager 106 of FIG. 1 and presented on the display 104.

The roster summary 1240 may include a comparison of player information 1228 from different players. In some embodiments, the player information 1228 may include points in the current game, average points per game, number of 3-point shots attempted/made in the game and in the season, number of 2-point shots attempted/made in the game and in the season, number of free throws made/attempted in the game and in the season, any other player information, and combinations thereof. In some embodiments, the player information from the season, such as season shooting percentages, may be highlighted or otherwise shown as different. For example, in the embodiment shown, the season shooting percentages are shown in bold lettering. This may allow a user or a coach to quickly compare who is playing well in the current game and who could use some improvement. This may help a coach or other user to change a lineup or otherwise change the roster to allow players who are performing well to play more, thereby improving the chances of winning a game.

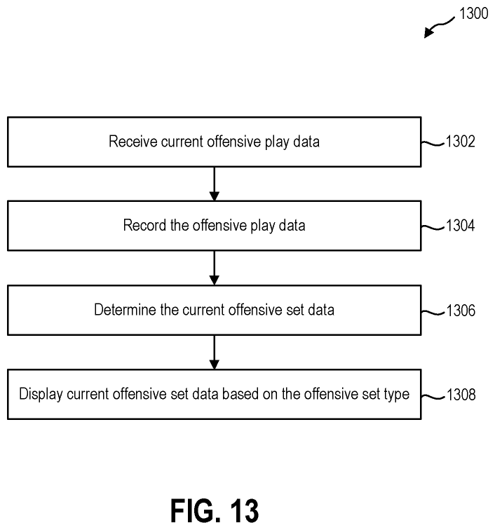

FIG. 13 is a representation of a method 1300 for analyzing a basketball game, according to at least one embodiment of the present disclosure. The method 1300 may include receiving 1302 current offensive play data of a current offensive play. In some embodiments, the current offensive play data may be received during an offensive possession. The offensive play data my include one or more of an offensive set type, a number of passes during the current offensive play, a possession-ending action (such as a shot or a turnover), a shot player, a shot location, and a shot result.

The method 1300 may include recording 1304 the offensive play data in an offensive play database. The analysis manager (e.g., the analysis manager 106 of FIG. 1) may determine 1306 current offensive set data for the current offensive play data and display 1308 the current offensive set data based on the offensive set type. In some embodiments, player information, such as a shot percentage for the offensive set type, may be displayed for a roster of players. In some embodiments, a season shot percentage of the offensive set may be displayed. In some embodiments, a season shot percentage may be determined relative to an opposing team. In some embodiments, the season shot percentage may be determined relative to a selected group of games.

In some embodiments, the current offensive set type may be specific to the roster of player. When the roster of players is changed, then the offensive set data displayed may be changed to reflect the offensive set data specific to the offensive set type and the changed roster of players.

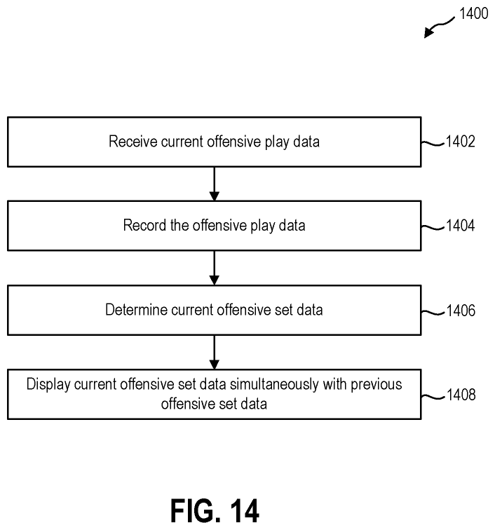

FIG. 14 is a representation of a method 1400 for analyzing a basketball game, according to at least one embodiment of the present disclosure. The method 1400 may include receiving 1402 current offensive play data of a current offensive play. In some embodiments, the current offensive play data may be received during an offensive possession. The offensive play data my include one or more of an offensive set type, a number of passes during the current offensive play, a possession-ending action (such as a shot or a turnover), a shot player, a shot location, and a shot result.

The method 1400 may include recording 1404 the offensive play data in an offensive play database. The analysis manager (e.g., the analysis manager 106 of FIG. 1) may determine 1406 current offensive set data for the current offensive play data. The offensive set data may include a comparison between current offensive set data and previous offensive set data in the offensive play database. The analysis manager may then display 1408 the current offensive set data on a display. In some embodiments, the current offensive set data may be display simultaneously with the previous offensive set data.

In some embodiments, multiple offensive set types may be displayed. In some embodiments, the current offensive set data and the previous offensive set data may include the same offensive set type. In some embodiments, the offensive set data includes a shot percentage of the offensive set type, and the shot percentage may include a player shot percentage based on the shot player. In some embodiments, the shot percentage may include a roster shot percentage based on an identified roster of players performing the current offensive play. In some embodiments, the shot percentage may include a turnover rate based on the offensive set type.

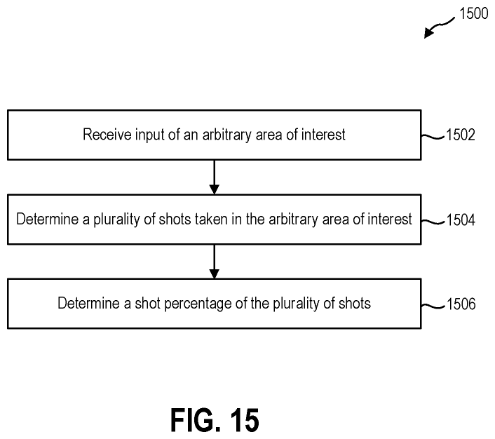

FIG. 15 is a representation of a method 1500 for analyzing a basketball game, according to at least one embodiment of the present disclosure. The method 1500 may include receiving 1502 an input of an arbitrary area of interest on a basketball court. An analysis manager (e.g., the analysis manager 106 of FIG. 1) may determine 1504 a plurality of shots taken in the arbitrary area of interest. Each shot may include a shot result, and the analysis manager may determine 1506 a shot percentage of the plurality of shots based on the shot result.

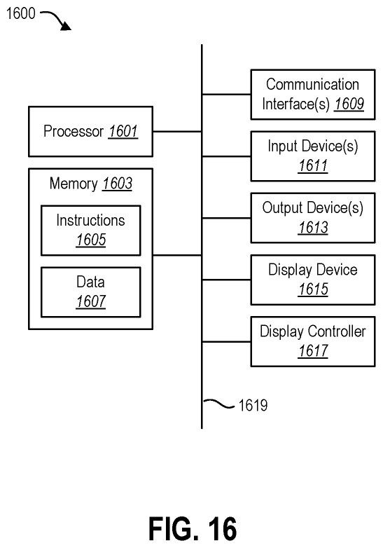

Reference is now made to FIG. 16. One or more computing devices 1600 can be used to implement at least some aspects of the techniques disclosed herein. FIG. 16 illustrates certain components that can be included within a computing device 1600. The computing device 1600 shown in FIG. 16 is an example of the computing system 100 shown in FIG. 1.

The computing device 1600 includes a processor 1601 and memory 1603 in electronic communication with the processor 1601. Instructions 1605 and data 1607 can be stored in the memory 1603. The instructions 1605 can be executable by the processor 1601 to implement some or all of the methods, steps, operations, actions, or other functionality that is disclosed herein. Executing the instructions 1605 can involve the use of the data 1607 that is stored in the memory 1603. Unless otherwise specified, any of the various examples of modules and components described herein can be implemented, partially or wholly, as instructions 1605 stored in memory 1603 and executed by the processor 1601. Any of the various examples of data described herein can be among the data 1607 that is stored in memory 1603 and used during execution of the instructions 1605 by the processor 1601.

Although just a single processor 1601 is shown in the computing device 1600 of FIG. 16, in an alternative configuration, a combination of processors (e.g., an ARM and DSP) could be used.

The computing device 1600 can also include one or more communication interfaces 1609 for communicating with other electronic devices. The communication interface(s) 1609 can be based on wired communication technology, wireless communication technology, or both. Some examples of communication interfaces 1609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computing device 1600 can also include one or more input devices 1611 and one or more output devices 1613. Some examples of input devices 1611 include a keyboard, mouse, microphone, remote control device, button, joystick, trackball, touchpad, and lightpen. One specific type of output device 1613 that is typically included in a computing device 1600 is a display device 1615. Display devices 1615 used with embodiments disclosed herein can utilize any suitable image projection technology, such as liquid crystal display (LCD), light-emitting diode (LED), gas plasma, electroluminescence, or the like. A display controller 1617 can also be provided, for converting data 1607 stored in the memory 1603 into text, graphics, and/or moving images (as appropriate) shown on the display device 1615. The computing device 1600 can also include other types of output devices 1613, such as a speaker, a printer, etc.

The various components of the computing device 1600 can be coupled together by one or more buses, which can include a power bus, a control signal bus, a status signal bus, a data bus, etc. For the sake of clarity, the various buses are illustrated in FIG. 16 as a bus system 1619.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, on-board memory included with a processor, erasable programmable read-only memory (EPROM), electrically erasable programmable read-only memory (EEPROM) memory, registers, and so forth, including combinations thereof.

As an example, the term “circuitry” can refer to one or more integrated circuits, where an integrated circuit can include a set of electronic circuits on a piece of semiconductor material (e.g., silicon). In some embodiments, circuitry can include programmable logic devices such as field programmable gate arrays (FPGAs) and/or complex programmable logic devices (CPLDs). In some embodiments, circuitry can include application specific integrated circuits (ASICs). As another example, the term “circuitry” can refer to one or more discrete electronic circuits that include individual electronic components. As another example, the term “circuitry” can refer to a digital circuit, an analog circuit, or a mixed-signal circuit. “Circuitry” can also include combinations of the foregoing.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

Systems and methods according to the present disclosure may be performed using any of the technological systems described herein. Furthermore, embodiments of the present disclosure may be implemented using computing technology, hardware and software, not currently available, or which may become available in the future.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for analyzing a basketball game, comprising:
during an offensive possession, receiving current offensive play data of a current offensive play, the offensive play data including an offensive set type and at least one of a number of passes during the current offensive play, a possession-ending action during the current offensive play, the possession-ending action including a shot or a turnover, or, if the possession-ending action is a shot, receiving a shot player, a shot location, and a shot result;
recording the offensive play data in an offensive play database;
determining current offensive set data for the current offensive play data; and
displaying the current offensive set data based on the offensive set type.

2. The method of claim 1, further comprising displaying player information for a roster of players, the player information including a shot percentage for the offensive set type.

3. The method of claim 2, wherein the current offensive set data is specific to the roster of players, and further comprising:
changing the roster of players; and
based on the changed roster of players, displaying offensive set data specific to the changed roster of players.

4. The method of claim 3, wherein changing the roster of players includes substituting a player.

5. The method of claim 1, further comprising displaying a season shot percentage of the offensive set data.

6. The method of claim 5, wherein the season shot percentage is determined relative to a selected group of games.

7. The method of claim 1, further comprising displaying offensive set data for a period of time during the basketball game, the period of time being the last two minutes of the basketball game.

8. A method for analyzing a basketball game, comprising:
during an offensive possession, receiving current offensive play data of a current offensive play, the current offensive play data including an offensive set type and at least one of a number of passes during the current offensive play, a possession-ending action during the current offensive play, the possession-ending action including a shot or a turnover, or, if the possession-ending action is a shot, receiving a shot player, a shot location, and a shot result;
recording the current offensive play data in an offensive play database;
determining current offensive set data for the current offensive play data, wherein the current offensive set data includes a comparison between the current offensive set data and previous offensive set data in the offensive play database; and
displaying the current offensive set data on a display such that the current offensive set data is displayed simultaneously with the previous offensive set data.

9. The method of claim 8, wherein the offensive set type is a first offensive set type, and wherein the previous offensive set data includes a second offensive set type, the second offensive set type being different from the first offensive set type.

10. The method of claim 8, wherein the previous offensive set data includes offensive set data from a group of games.

11. The method of claim 8, further comprising displaying offensive set data for a period of time during the basketball game, the period of time being the last two minutes of the basketball game.

12. The method of claim 8, wherein the current offensive set data includes a shot percentage of the offensive set type.

13. The method of claim 12, wherein the shot percentage includes a player shot percentage based on the shot player.

14. The method of claim 12, wherein the shot percentage includes a turnover rate based on whether the possession-ending action is a turnover.

15. A method for analyzing a basketball game, comprising:
receiving an input of an arbitrary area of interest on a basketball court;
determining a plurality of shots taken in the arbitrary area of interest, each shot of the plurality of shots including a shot result; and
determining a shot percentage of the plurality of shots based on the shot result of each shot of the plurality of shots.

16. The method of claim 15, wherein the arbitrary area of interest is a circle having a center locatable at any point on the basketball court.

17. The method of claim 15, wherein each shot of the plurality of shots includes a shot player, and wherein determining the shot percentage includes determining a player shot percentage based on the shot player and the shot result.

18. The method of claim 15, wherein each shot of the plurality of shots includes a shot element indicating whether each shot of the plurality of shots is a catch-and-shoot shot.

19. The method of claim 15, wherein determining the plurality of shots taken includes querying a database of shots taken.

20. The method of claim 19, wherein each shot in the database of shots includes a shot location, and wherein determining the plurality of shots taken includes determining whether the shot location for a shot in the database of shots is located within the arbitrary area of interest.
